(19) United States
(12) Patent Application Publication
(10) Pub. No.: US 2016/0381652 A1
(43) Pub. Date: Dec. 29, 2016

(54) METHOD AND APPARATUS FOR DETECTION OF SYNCHRONIZATION SIGNALS IN WIRELESS NETWORKS

(71) Applicant: Nokia Technologies Oy, Espoo (FI)

(72) Inventors: Panayiotis PAPADIMITRIOU, Espoo (FI); Ankit BHAMRI, Espoo (FI); Lars E. LINDH, Helsingfors (FI); Cássio RIBEIRO, Espoo (FI)

(21) Appl. No.: 14/883,974

(22) Filed: Oct. 15, 2015

(30) Foreign Application Priority Data
Jun. 24, 2015 (GR) 20150100289

(51) Int. Cl. H04W 56/00; H04L 12/26

(52) U.S. Cl. CPC H04W 56/001; H04L 43/16

(57) ABSTRACT

Various communication systems may benefit from an accurate cell detection method. The method may include determining at least one first correlation value between a first sequence of received samples and at least one pre-defined sequence, determining at least one second correlation value between a second sequence of received samples at a predetermined distance and the at least one pre-defined sequence, wherein the predetermined distance is substantially more than one symbol and substantially less than two symbols, performing summing of at least the at least one first correlation value and the at least one second correlation value to obtain at least one summed correlation value and detecting whether at least one peak exists by comparing the at least one summed correlation value with a detection threshold.

### TECHNICAL FIELD

The present application relates generally to synchronization, such as, for example, to detection of synchronization signals in wireless networks.

### BACKGROUND

Long Term Evolution, LTE, is a wireless communication system developed by the 3^{rd} Generation Partnership Project, 3GPP. In LTE cell detection and initial synchronization are based on two synchronization signals, a Primary Synchronization Signal, PSS, and a Secondary Synchronization Signal, SSS. One of the topics in LTE is device-to-device, D2D, communications and 3GPP is finalizing the specifications for certain D2D operations at the moment. In the context of D2D communications a Primary Device-to-Device Synchronization Signal, PD2DSS, corresponds to the PSS functionality while a Secondary Device-to-Device Synchronization Signal, SD2DSS, corresponds to the SSS functionality.

Synchronization signals are also employed in other wireless cellular systems such as Wideband Code Division Multiple Access, WCDMA, and CDMA2000, for example. In addition to different wireless cellular systems, synchronization signals are used in several other wireless systems, such as, Wireless Local Area Network, WLAN, and Worldwide Interoperability for Microwave Access, WiMAX, systems as well.

### SUMMARY

According to certain embodiments, an apparatus may comprise at least one processor and at least one memory including computer program code, the at least one memory and the computer program code being configured to, with the at least one processor, cause the apparatus at least to determine at least one first correlation value between a first sequence of received samples and at least one pre-defined sequence, determine at least one second correlation value between a second sequence of received samples at a predetermined distance and the at least one pre-defined sequence, wherein the predetermined distance is substantially more than one symbol and substantially less than two symbols, perform summing of at least the at least one first correlation value and the at least one second correlation value to obtain at least one summed correlation value and detect whether at least one peak exists by a comparison of the at least one summed correlation value with a detection threshold.

According to certain embodiments, a method may include determining at least one first correlation value between a first sequence of received samples and at least one pre-defined sequence, determining at least one second correlation value between a second sequence of received samples at a predetermined distance and the at least one pre-defined sequence, wherein the predetermined distance is substantially more than one symbol and substantially less than two symbols, performing summing of at least the at least one first correlation value and the at least one second correlation value to obtain at least one summed correlation value and detecting whether at least one peak exists by comparing the at least one summed correlation value with a detection threshold.

According to certain embodiments, a computer program product, embodied on a non-transitory computer readable medium, may be configured to control a processor to perform a process, comprising determining at least one first correlation value between a first sequence of received samples and at least one pre-defined sequence, determining at least one second correlation value between a second sequence of received samples at a predetermined distance and the at least one pre-defined sequence, wherein the predetermined distance is substantially more than one symbol and substantially less than two symbols, performing summing of at least the at least one first correlation value and the at least one second correlation value to obtain at least one summed correlation value and detecting whether at least one peak exists by comparing the at least one summed correlation value with a detection threshold.

### BRIEF DESCRIPTION OF THE DRAWINGS

For a more complete understanding of example embodiments of the present invention, reference is now made to the following descriptions taken in connection with the accompanying drawings in which:

FIG. 1 illustrates an example of a network scenario according to some example embodiments of the invention.

FIG. 2 illustrates an example of a D2D subframe, comprising PD2DSSs and SD2DSSs.

FIG. 3 illustrates a block diagram in accordance with at least some embodiments of the invention.

FIG. 4 illustrates a flowchart of a method in accordance with at least some embodiments of the invention.

FIG. 5 illustrates an apparatus according to at least some embodiments of the invention.

### DETAILED DESCRIPTION

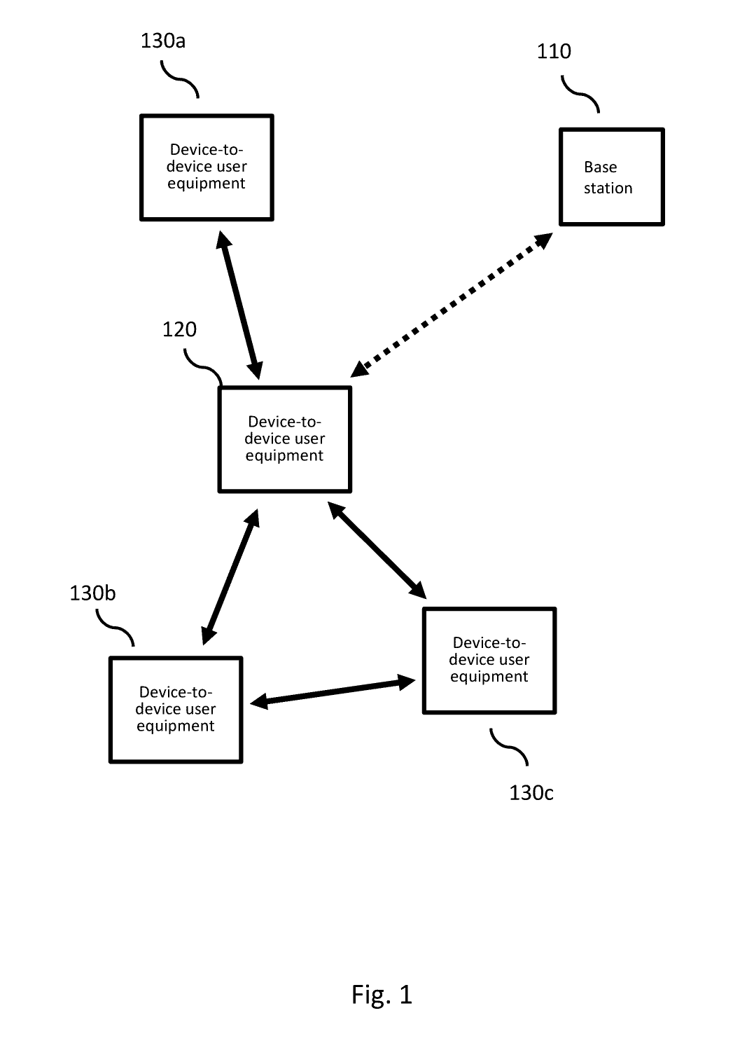

FIG. 1 represents an example of a network scenario according to embodiments of the invention. In this example, the network comprises a base station, BS, (110) and multiple user equipments, UEs, (120, 130a, 130b, 130c). According to the example some, or all, of the UEs (120, 130a, 130b, 130c) may be able to communicate directly with the BS (110). In addition, or alternatively, in certain embodiments of the invention some, or all, of the UEs (120, 130a, 130b, 130c) may be capable of participating in D2D communications. Generally speaking, D2D communications may be defined as direct wireless communications between UEs (120, 130a, 130b, 130c). That is to say, in case of D2D communications transmissions may not necessarily traverse any intermediate node, such as the BS (110).

In an embodiment, a cell synchronization may be acquired first if a UE (120, 130a, 130b, 130c) desires to camp on a cell in LTE networks. After that the UE may determine a Physical Cell Identity, PCI. In addition the UE (120, 130a, 130b, 130c) may determine frame and time synchronization as well. The process may be performed as follows. The UE (120, 130a, 130b, 130c) may receive a signal from a BS (110) wherein the signal comprises a PSS. Once the UE (120, 130a, 130b, 130c) has found the PSS it may synchronize to the BS (110) on a subframe level.

The UE (120, 130a, 130b, 130c) may also look for a SSS. Generally speaking, in case of LTE systems the SSS may be found in the same subframe as the PSS. The UE (120, 130a, 130b, 130c) may then acquire a PCI group number from the SSS, and locate reference signals based, at least in part, on that. Reference signals may then be exploited for channel estimation, etc. In other systems broadly similar procedures are defined for causing a UE to camp in a cell. For example, in Wideband Code Division Multiple Access, WCDMA, networks an attach procedure may be performed as well.

There is a similar concept in case of D2D communications, wherein PSSs and SSSs may be named as PD2DSSs and SD2DSSs, respectively. According to certain embodiments of the invention, a D2D UE (120, 130a, 130b, 130c) may receive the PD2DSS/SD2DSS from another D2D UE (120, 130a, 130b, 130c). Alternatively, or in addition, in some embodiments the PD2DSS/SD2DSS may be possibly received from the BS (110), an access point or any other device capable of wireless communication.

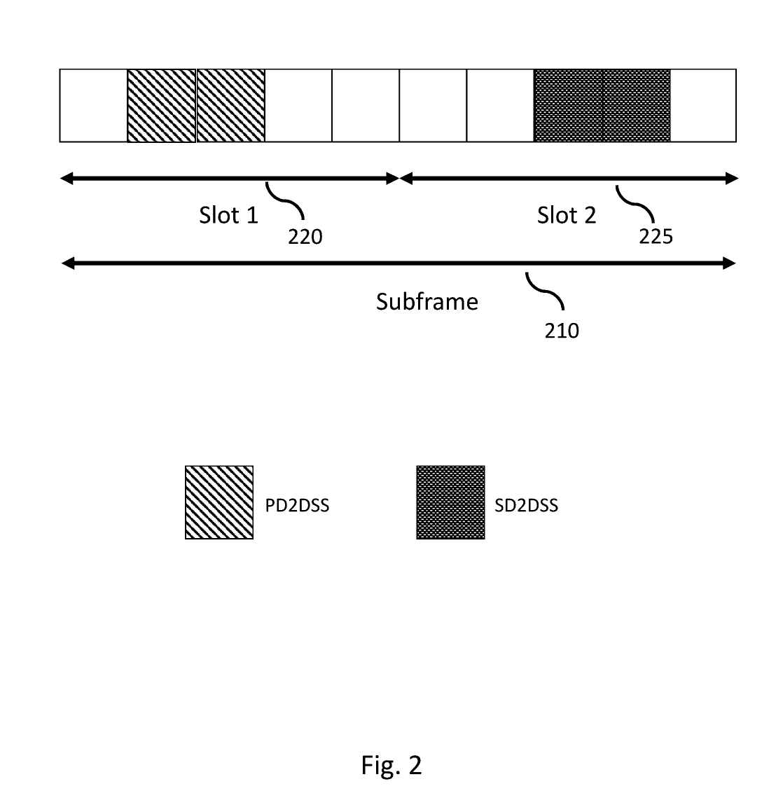

Turning now to FIG. 2, illustrated is an example of a D2D subframe (210), comprising PD2DSS and SD2DSS. According to the example of FIG. 2 the D2D subframe may comprise two slots, slot 1, 220 and slot 2, 225. However, in some embodiments there may be more than one subframe (210). Furthermore, in some embodiments there may be more than two slots (220, 225) in one subframe (210). In case of D2D, two PD2DSSs may be located in one slot, as subsequent Orthogonal Frequency Division Multiplexing, OFDM, symbols. Similarly, in case of D2D two SD2DSSs may be located in another slot as subsequent OFDM symbols.

Also, PD2DSSs and SD2DSSs may possibly extend over several subcarriers. For example, in case of OFDM systems, PD2DSSs and SD2DSSs may extend over several OFDM subcarriers so that PD2DSSs and PD2DSSs comprise one or more OFDM samples. Alternatively, or in addition, PD2DSSs and SD2DSSs may be within one Physical Resource Block, PRB, which comprises one or more subcarriers, or extend over several PRBs as well.

Referring to FIG. 2 again, a sequence of samples may correspond to the entire D2D subframe or a part of it. According to various embodiments of the invention the sequence of samples may refer to a PD2DSS, a SD2DSS or any other part of a subframe or a slot. In some embodiments PD2DSSs and SD2DSS may be OFDM symbols while the sequence of samples may refer to OFDM samples that correspond to the OFDM symbols. That is to say, the sequence of samples may be transmitted over several OFDM subcarriers. Nevertheless, the present invention is not restricted to any specific definition of the sequence of samples, that is, a person skilled in the art will understand how to apply the invention in different wireless systems that may have various subframe and slot configurations or different definitions of a sequence of samples.

In an embodiment, synchronization is performed by exploiting at least one pre-defined sequence. In some embodiments the at least one pre-defined sequence may be specified in a standard. As an example, the standard may be a 3GPP standard or any other wireless communication standard, such as Wireless Local Area Network, WLAN, and Worldwide Interoperability for Microwave Access, WiMAX, standard families. Examples of the at least one pre-defined sequence include, but are not limited to, PSSs, SSSs, PD2DSSs and SD2DSSs.

A receiver may not know the positions of PD2DSSs and SD2DSSs. However, a distance between two PD2DSSs may be predetermined, for example, by a 3GPP standard or any other wireless communication standard, such as WLAN and WiMAX standard families. In some embodiments the predetermined distance may be defined at the receiver as well.

The predetermined distance may be a distance between two sequences of samples in a subframe. For example, the predetermined distance may be defined as a number of symbols or samples between two PD2DSSs and/or SD2DSSs. Certain embodiments of the invention exploit this observation to provide an accurate detection method for LTE and D2D synchronization in the 3GPP LTE framework. Nevertheless, the embodiments of the invention are not limited to LTE and hence, the invention may be utilized in other wireless systems and networks as well, such as, for example, in WCDMA, WLAN or WiMAX networks.

The following provides examples of how this could be achieved in a wireless network. A receiver may first determine at least one first correlation value between a first sequence of received samples and at least one pre-defined sequence, and at least one second correlation value between a second sequence of received samples at a predetermined distance and the at least one pre-defined sequence, wherein the predetermined distance may be substantially more than one symbol and substantially less than two symbols. After that, the receiver may perform summing of at least the at least one first correlation value and the at least one second correlation value to obtain at least one summed correlation value, and further detect whether at least one peak exists by a comparison of the at least one summed correlation value with a detection threshold.

In the context of D2D communications, a D2D UE may first determine at least one first correlation value between a first sequence of received OFDM samples and at least one reference PD2DSS, and at least one second correlation value between a second sequence of received OFDM samples at a predetermined distance and the at least one reference PD2DSS, wherein the predetermined distance may be substantially more than one OFDM symbol and substantially less than two OFDM symbols. After that, the D2D UE may perform summing of at least the at least one first correlation value and the at least one second correlation value to obtain at least one summed correlation value, and further detect whether at least one peak exists by a comparison of the at least one summed correlation value with a detection threshold. In some embodiments the second sequence of received OFDM samples may overlap with the first sequence of received OFDM samples at least partially.

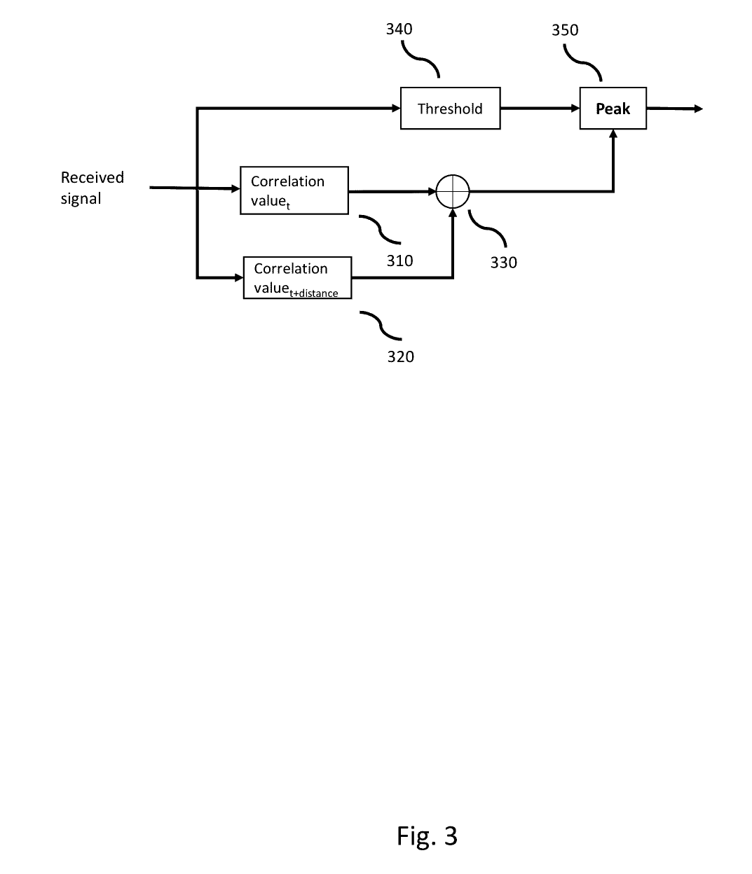

FIG. 3 depicts a block diagram of a process in accordance with at least some embodiments of the invention. The phases of the illustrated method may be performed by a D2D UE, for example, or a control device that is configured to control the functioning of a D2D UE when implanted therein. In the beginning of the process, a D2D UE may first receive a signal. The received signal may comprise a first sequence of received samples and, potentially, a second sequence of received samples as well. After reception of the signal, the D2D UE may process it as follows.

Referring to block 310 in FIG. 3, the received signal, comprising at least one first sequence of received samples, may be correlated with at least one pre-defined sequence to determine at least one first correlation value. In some embodiments the at least one pre-defined sequence may comprise a PD2DSS. As an example, in certain cases there may be only one pre-defined sequence while in some other embodiments there may be two, three or even more pre-defined sequences. According to the current LTE standard, there may be three pre-defined sequences typically.

In addition, referring to block 320 of FIG. 3, the received signal may also comprise a second sequence of received samples at a predetermined distance, and the second sequence of received samples may be correlated with the at least one pre-defined sequence as well, to determine at least one second correlation value. The predetermined distance may be the distance in samples between the first and the second sequences of received samples. In some embodiments the second sequence of received samples may overlap with the first sequence of received samples at least partially. That is to say, the second sequence of received samples may be partially overlapping with the first sequence of received samples at the predetermined distance.

In some embodiments the received signal may comprise a subframe, wherein the subframe may further comprise the first and the second sequences of received samples. In addition, or alternatively, in some embodiments the received signal may comprise a part of a previous subframe, and/or more than a subframe and less than two subframes. Moreover, in some embodiments the subframe may comprise more than one slot and in such case, the first and the second sequences of received samples may be located in the same slot.

In some embodiments the second sequence of received samples at the predetermined distance may be determined by buffering or time-delaying the received signal at the receiver by the predetermined distance. It should be noted that the time-delaying may not be related to multipath delays, instead the time-delaying may be performed by the receiver using the same version of the received signal. In some embodiments the received signal may be a D2D time-domain signal.

The predetermined distance may be counted in various ways. For example, the predetermined distance may be counted in symbols. In case of OFDM symbols the predetermined distance may be for example 0.5 (half), 1 or 1.5 or 2 OFDM symbols, before sampling. The predetermined distance may be counted after sampling as well. For example, if one OFDM symbol corresponds to 64 OFDM samples after down-sampling, in such case the predetermined distance may be for example 64 or 96 or 128 OFDM samples.

More specifically, according to the invention the predetermined distance may be substantially more than one OFDM symbol and substantially less than two OFDM symbols. For example, if one OFDM symbol corresponds to 64 OFDM samples after down-sampling, the predetermined distance may be substantially more than 64 OFDM samples and substantially less than 128 OFDM samples. In some embodiments the predetermined distance may be, for example, 95 (64+32−1) OFDM samples.

Referring to block 330 in FIG. 3, the D2D UE may then perform summing of at least the at least one first correlation value and the at least one second correlation value to obtain at least one summed correlation value. In certain cases only one summed correlation value may be obtained while in some other embodiments two, three or even more summed correlation values may be obtained, depending on the amount of first and second correlation values. Hence, in some embodiments the D2D UE may correlate and perform summing for each possibly transmitted PD2DSS.

In some embodiments, the D2D UE may perform the summing of at least the at least one first correlation values and the at least one second correlation values by summing absolute squares of the at least one first correlation values and the at least one second correlation values, to obtain at least one summed correlation value. In such cases the D2D UE may further divide the at least one summed correlation value by two, to be used for further processing.

Referring to block 340 of FIG. 3, the D2D UE may determine a detection threshold based at least in part on an energy of the received signal. In general, the detection threshold may be determined, for example, based on an energy of samples and/or desired probability of false alarm/detection.

Then, referring to block 350 of FIG. 3, the D2D UE may finally detect whether at least one peak exists by exploiting the at least one summed correlation value from block 330 and the detection threshold from block 340. The at least one peak may thereby be detected by using knowledge of the predetermined distance, wherein the predetermined distance may be substantially more than one symbol and substantially less than two symbols. In some embodiments, the predetermined distance may be substantially more than one OFDM symbol and substantially less than two OFDM symbols.

According to certain embodiments of the invention, the D2D UE may detect whether the at least one peak exists by a comparison of the at least one summed correlation value with the detection threshold and if the at least one summed correlation value is larger, or equal, compared to the detection threshold, at least one peak exists. Consequently, the D2D UE may determine the existence and locations of, for example, two PD2DSSs based on the detection of the at least one peak.

In some embodiments, the D2D UE may store the at least one peak that exceeded the threshold and was consequently detected at block 350, together with at least one corresponding PD2DSS index. The D2D UE may then use the detected at least one peak and the at least one corresponding PD2DSS index as candidate PD2DSSs for subsequent detection of SD2DSS.

In some embodiments an intermediate decision on PD2DSSs may be required, before detecting SD2DSSs. In such cases, the highest detected peak corresponding to a certain PD2DSS may be chosen. However, if the intermediate decision on PD2DSSs is not required, the D2D UE may choose the PD2DSS after SD2DSS detection, since SD2DSS detection gives the cell PCI (or Network Identification, NID) and the D2D UE may choose the PD2DSS from the detected PCI.

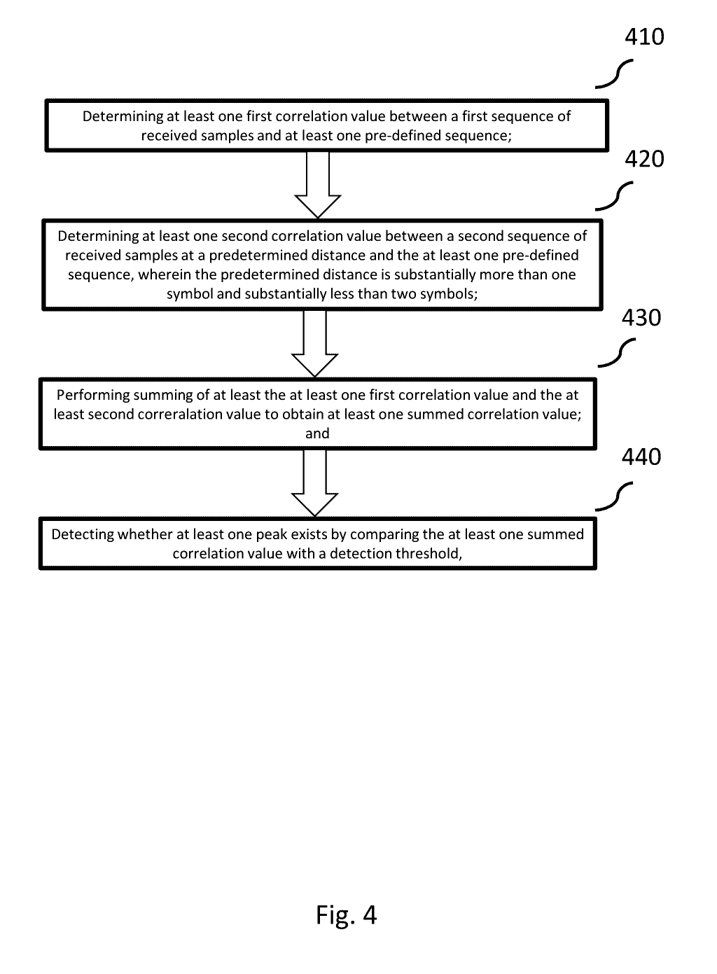

Turning now to FIG. 4, which demonstrates a method according to at least some embodiments, the method may include, for example, receiving by a first D2D UE a signal from a second D2D UE. The received signal may be a D2D time-domain signal, and it may comprise a first and a second sequence of received samples. As shown in FIG. 4, the method may include, at 410, determining at least one first correlation values between the first sequence of received samples and at least one pre-defined sequence. In some embodiments the at least one pre-defined sequence may be a primary device-to-device synchronization signal, PD2DSS.

The method may also include, at 420, determining at least one second correlation value between a second sequence of received samples at a predetermined distance and the at least one pre-defined sequence, wherein the predetermined distance is substantially more than one symbol and substantially less than two symbols. In some embodiments, the predetermined distance may be the distance between the first sequence of received samples and the second sequence of received samples.

At 430, the method may include performing summing of at least the at least one first correlation value and the at least one second correlation value to obtain at least one summed correlation value. In some embodiments, performing the summing of at least the at least one first correlation values and the at least one second correlation values may further comprise summing absolute squares of the at least one first correlation values and the at least one second correlation values.

The method may also include, at 440, detecting whether at least one peak exists by comparing the at least one summed correlation value with a detection threshold. Finally, the method may include identifying the primary device-to-device synchronization sequence based at least in part on the detected at least one peak.

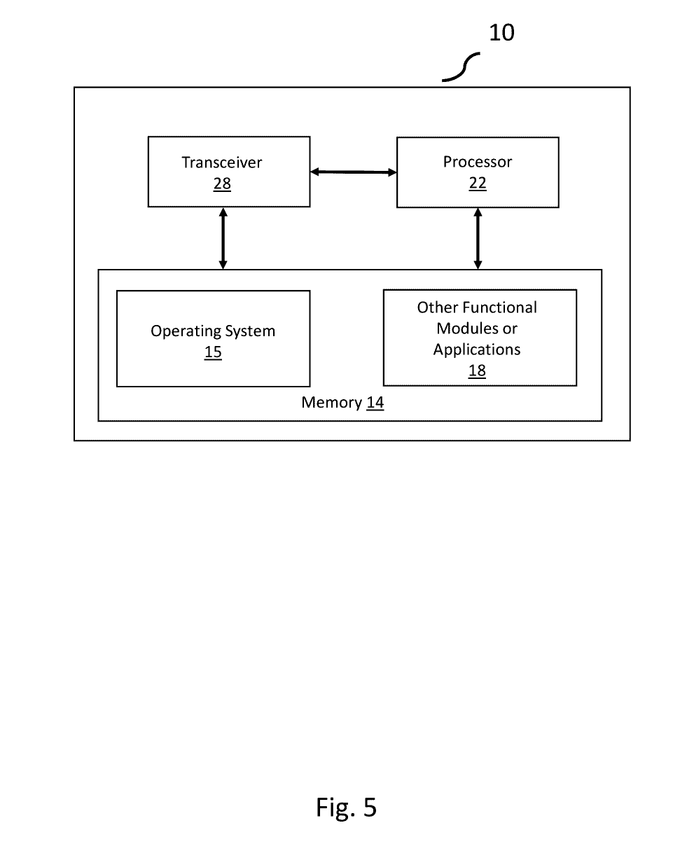

FIG. 5 illustrates an apparatus 10 according to at least some embodiments of the invention. Apparatus 10 may be a wireless device, such as a user equipment or a device-to-device user equipment, for example.

The wireless device, user equipment or device-to-device user equipment may be a mobile station such as a mobile phone or smart phone or multimedia device, a computer, such as a tablet, provided with wireless communication capabilities, personal data or digital assistant, PDA, provided with wireless communication capabilities, portable media player, digital camera, pocket video camera, navigation unit provided with wireless communication capabilities or any combinations thereof, for example, the wireless device, user equipment or device-to-device user equipment may be a sensor or smart meter, or other device that may usually be configured for a single location. Additionally, the wireless device, user equipment or device-to-device user equipment may be a device suitable for machine-type-communications.

Apparatus 10 may comprise a processor 22 for processing information and executing instructions or operations. Processor 22 may be any type of suitable general or specific purpose processor. For example, processor 22 may comprise a Qualcomm Snapdragon or Intel Atom processor. Processor 22 may comprise at least one processing core, such as for example an Advanced Micro Devices, AMD, Steamroller or NVIDIA Denver core. While a single processor 22 is shown in FIG. 5, multiple processors may be utilized according to other embodiments. Processor 22 may comprise one or more of general-purpose computers, special purpose computers, microprocessors, digital signal processors, DSPs, field-programmable gate arrays, FPGAs, application-specific integrated circuits, ASICs, and processors based on a multi-core processor architecture, as examples.

Apparatus 10 may further comprise a memory 14, coupled to processor 22, for storing information and instructions that may be executed by processor 22. Memory 14 may comprise one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory, RAM, read only memory, ROM, static storage such as a magnetic or optical disk, or any other type of non-transitory machine or computer readable media. The instructions stored in memory 14 may comprise program instructions or computer program code that, when executed by processor 22, enable the apparatus 10 to perform tasks as described herein. Memory 14 may be at least in part comprised in processor 22.

Apparatus 10 may also comprise one or more antennas (not shown) for transmitting and receiving signals and/or data to and from apparatus 10. Apparatus 10 may further comprise a transceiver 28 that modulates information on to a carrier waveform for transmission by the antenna(s) and demodulates information received via the antenna(s) for further processing by other elements of apparatus 10. In other embodiments, transceiver 28 may be capable of transmitting and receiving signals or data directly.

Processor 22 may perform functions associated with the operation of apparatus 10 comprising, without limitation, precoding of antenna gain/phase parameters, encoding and decoding of individual bits forming a communication message, formatting of information, and overall control of the apparatus 10, comprising processes related to management of communication resources. Processor 22 may comprise a receiver and/or transmitter configured to enable processor 22 to communicate with other components of apparatus 10, such as, for example, memory 14.

In an embodiment, memory 14 may store software modules that provide functionality when executed by processor 22. The modules may comprise an operating system 15 that provides operating system functionality for apparatus 10. The memory may store one or more functional modules 18, such as an application or program, to provide additional functionality for apparatus 10. The components of apparatus 10 may be implemented in hardware, or as any suitable combination of hardware and software.

The described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

Moreover, one having ordinary skill in the art will readily understand that the invention as discussed above may be practiced in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

In an exemplary embodiment, an apparatus, such as a user equipment or a D2D UE, may include means for carrying out embodiments described above and any combination thereof.

We claim:

1. An apparatus, comprising:
at least one processor; and
at least one memory including computer program code,
the at least one memory and the computer program code configured, with the at least one processor, to cause the apparatus at least to
determine at least one first correlation value between a first sequence of received samples and at least one pre-defined sequence;
determine at least one second correlation value between a second sequence of received samples at a predetermined distance and the at least one pre-defined sequence, wherein the predetermined distance is substantially more than one symbol and substantially less than two symbols;
perform summing of at least the at least one first correlation value and the at least one second correlation value to obtain at least one summed correlation value; and
detect whether at least one peak exists by a comparison of the at least one summed correlation value with a detection threshold.

2. The apparatus according to claim 1, wherein said one symbol is an Orthogonal Frequency Division Multiplexing symbol comprising one or more samples.

3. The apparatus according to claim 1, wherein the predetermined distance is the distance between the first sequence of received samples and the second sequence of received samples.

4. The apparatus according to claim 1, wherein the at least one memory and the computer program code are configured, with the at least one processor, to further cause the apparatus at least to
receive a signal comprising the first and the second sequences of received samples.

5. The apparatus according to claim 4, wherein the signal is a device-to-device time-domain signal.

6. The apparatus according to claim 4, wherein the at least one memory and the computer program code are configured, with the at least one processor, to further cause the apparatus at least to
determine the detection threshold based at least in part on an energy of the received signal.

7. The apparatus according to claim 1, wherein the at least one memory and the computer program code are configured, with the at least one processor, to further cause the apparatus at least to
determine the second sequence of received samples at the predetermined distance by time-delaying a received signal by the predetermined distance.

8. The apparatus according to claim 1, wherein the at least one memory, the computer program code and the processor are configured to cause the apparatus to
perform the summing of at least the at least one first correlation value and the at least one second correlation value by summing absolute squares of the at least one first correlation value and the at least one second correlation value.

9. The apparatus according to claim 1, wherein the first and the second sequence of received samples comprise Orthogonal Frequency Division Multiplexing samples.

10. The apparatus according to claim 1, wherein the at least one pre-defined sequence comprises a primary device-to-device synchronization sequence.

11. The apparatus according to claim 1, wherein the at least one memory and the computer program code are configured, with the at least one processor, to further cause the apparatus at least to
identify a primary device-to-device synchronization sequence based at least in part on the detected at least one peak.

12. The apparatus according to claim 1, wherein the second sequence of received samples overlaps with the first sequence of received samples at least partially.

13. The apparatus according to claim 1, wherein the apparatus is a user equipment configured to participate in a device-to-device communication.

14. The apparatus according to claim 13, wherein the device-to-device communication comprises direct wireless communication between user equipments that does not traverse any intermediate node.

15. A method, comprising:
determining at least one first correlation value between a first sequence of received samples and at least one pre-defined sequence;
determining at least one second correlation value between a second sequence of received samples at a predetermined distance and the at least one pre-defined sequence, wherein the predetermined distance is substantially more than one symbol and substantially less than two symbols;
performing summing of at least the at least one first correlation value and the at least one second correlation value to obtain at least one summed correlation value; and
detecting whether at least one peak exists by comparing the at least one summed correlation value with a detection threshold.

16. The method according to claim 15, wherein the second sequence of received samples overlaps with the first sequence of received samples at least partially.

17. The method according to claim 15, further comprising
determining the second sequence of received samples at the predetermined distance by time-delaying a received signal by the predetermined distance.

18. The method according to claim 15, further comprising
performing the summing of at least the at least one first correlation value and the at least one second correlation value by summing absolute squares of the at least one first correlation value and the at least one second correlation value.

19. The method according to claim 15, further comprising
identifying a primary device-to-device synchronization sequence based at least in part on the detected at least one peak.

20. A computer program product, embodied on a non-transitory computer readable medium, wherein
the computer program product is configured to control a processor to perform a process comprising:
determining at least one first correlation value between a first sequence of received samples and at least one pre-defined sequence;
determining at least one second correlation value between a second sequence of received samples at a predetermined distance and the at least one pre-defined sequence, wherein the predetermined distance is substantially more than one symbol and substantially less than two symbols;
performing summing of at least the at least one first correlation value and the at least one second correlation value to obtain at least one summed correlation value; and
detecting whether at least one peak exists by comparing the at least one summed correlation value with a detection threshold.
